(19) United States
(12) Patent Application Publication
(10) Pub. No.: US 2007/0294125 A1
(43) Pub. Date: Dec. 20, 2007

(54) TARGETED COLLECTION AND USE OF INFORMATION FROM JOB BOARDS, JOB LISTINGS AND SIMILAR SOURCES

(76) Inventor: David J. Thomsen, Newport Beach, CA (US)

Correspondence Address: PERKINS COIE LLP;PATENT-SEA, P.O. BOX 1247, SEATTLE, WA, 98111-1247, US

(21) Appl. No.: 11/619,177

(22) Filed: Jan. 2, 2007

Related U.S. Application Data
(60) Provisional application No. 60/755,104, filed on Dec. 30, 2005.

(51) Int. Cl. G06F 17/30

(52) U.S. Cl. 705/10

(57) ABSTRACT

A job board data collection facility collects computerized data from publicly available sources and using parameters relating to job skills and the like (as opposed to basing data collection on job titles). For example the facility may rely on collecting and organizing information based on one or more mathematical constructs and or contextual mapping specific to the application of data, demographics, and relationships keyed to the identification of certain job skills and remuneration paid to those individuals having those job skills.

### BRIEF DESCRIPTION OF THE DRAWINGS

FIG. 1 is a display diagram that provides an example of salary surveys that can be enhanced by use of the facility.

FIG. 2 is a display diagram that provides some examples of uses for skills data.

FIG. 3 is a display diagram showing an example of using residual functional capacity measures (RFCs) to define job skill statements.

FIG. 4 is a display diagram that illustrates an example of using skill-based parameters to mine Internet data from actual job postings.

FIGS. 6A and 6B display diagrams illustrating an example of a skill-based pay assessor.

### DETAILED DESCRIPTION

A software facility described herein (“the facility”) gathers public information (e.g., from the World Wide Web and/or other public electronic sources) for enhancing salary surveys and collections of work skill data. For example, in some embodiments, the facility studies and mines job boards and other online job resources (e.g., corporate listings, government unemployment and other agencies' job postings, etc.) for information (e.g., competitive salary rates, benefit costs, nonprofit pay practices and board members, cost of living data and new college hire rates, etc.) that may be used to enhance a salary survey or the like. In this and other applications, the studying and mining of job boards and other online job resources may be performed based on skill-based parameters (not just job titles). Performing studying and mining of job boards and other online job resources using skill-based parameters may also be used to help with enhancing databases used for transferable skills analysis and the like (e.g., in the context of Disability determination processes). Whether for disability determination, pay decisions, educational planning or other uses, the facility allows for tying of worker measures to skills to specific jobs and then allows for the actual finding of jobs that match all those inputs.

Targeted Collection of Data for Enhancing Salary Surveys

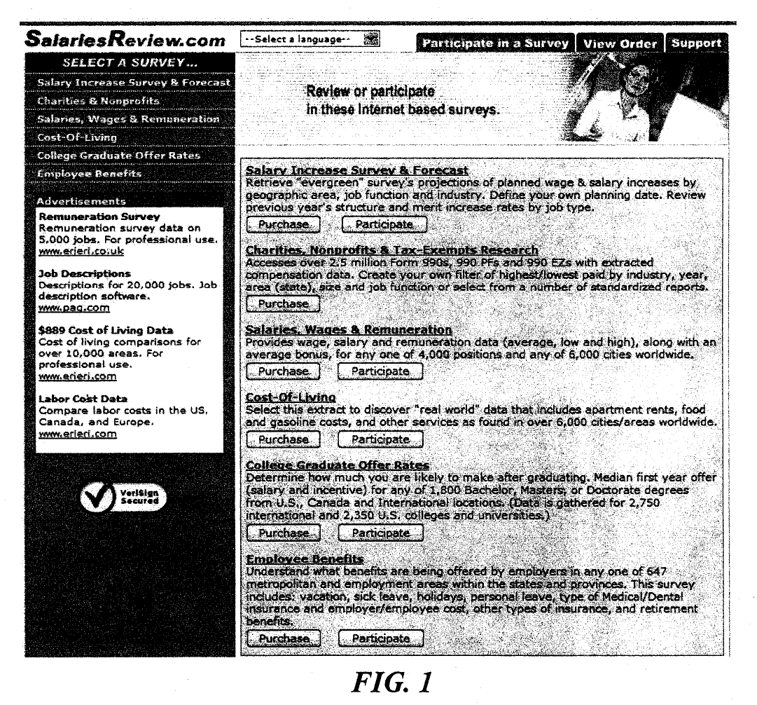

The facility can be used in combination with technology such as that described in “System and Method for Retrieving and Displaying Data, such as Economic Data Relating to Salaries, Cost of Living and Employee Benefits” (U.S. Pat. No. 6,862,596, filed on Apr. 18, 2002, and commonly owned at the time of this application). For example, the facility facilitates further populating salary surveys (e.g., www.salariesreview.com) with contemporary data. Specific examples of such surveys are depicted in FIG. 1, and include a Salary Increase Survey & Forecast survey; a Charities, Nonprofits & Tax-Exempts Research survey; a Salaries, Wages & Remuneration survey; a Cost-Of-Living survey; a College Graduate Offer Rates survey; and an Employee Benefits survey. In addition to collecting salary data for use such a context, the facility may also collect data related to salary data such as cost of living data, employee/employer benefit costs, college hire rates, board membership and data, increase rates, domestic demographics, international demographics, etc. The facility is built on a foundation of terms and relationships of terms and words within a mathematical construct specific to the applications of data, demographics, and relationships keyed to the identification of skills and remuneration paid for those skills.

In some embodiments, matching of jobs or other categories for salary survey and/or the matching of skill requirements (described in more detail below) is not an exact word matching exercise; but may, instead, employ one or more forms of contextual text mapping. Contextual mapping utilized by the facility uses a combination of word searching and mathematics (the relationship of words, one to another). The search algorithms used (including the relationships between terms) are continually updated via ongoing use of the facility (e.g., as in the cybernetic system described below). Thus, increased use of the facility provides refinement of algorithms and better results.

Targeted Collection of Data for Enhancing Job Skills Information

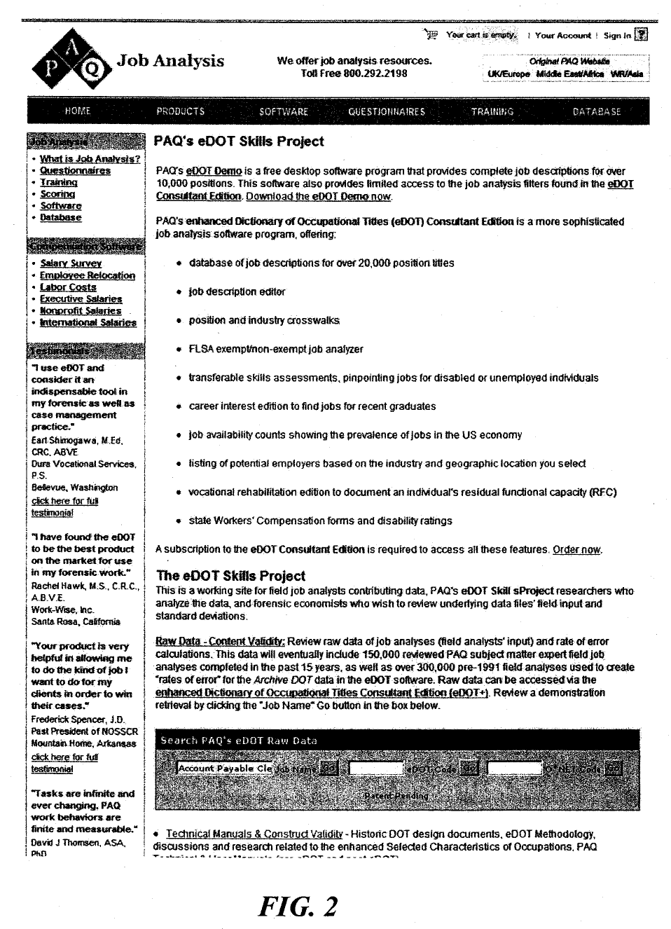

As described in detail in “System and Method for Providing Occupational Information” (U.S. patent application Ser. No. 10/806,044, filed on Mar. 22, 2004, and commonly owned at the time of this application), up-to-date occupational skills information (e.g., skills information based on actual worker measures) can have many different uses, such as transferable skills analysis, disability determination, pay decisions, educational planning, etc. Some of these uses are summarized in FIG. 2.

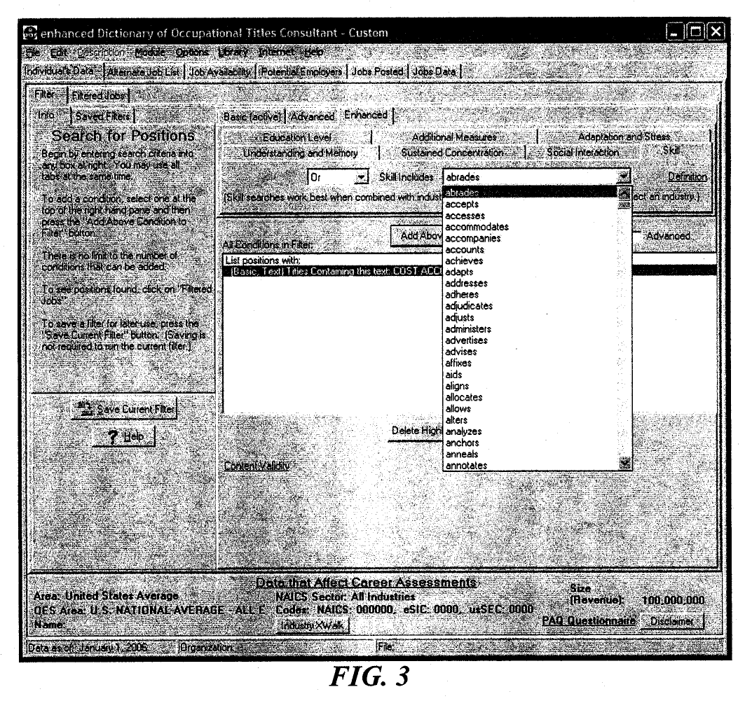

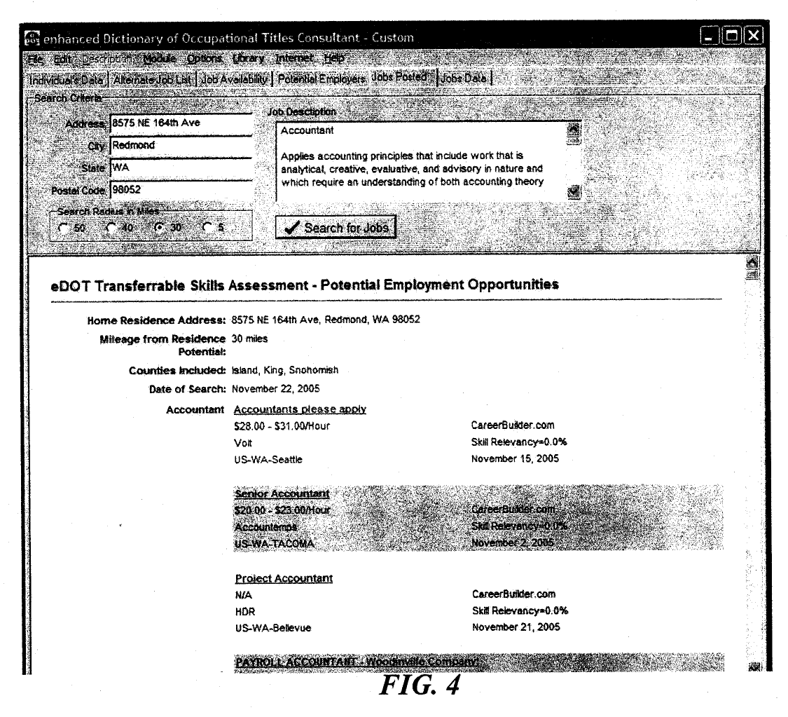

For example, through the use of one or more input mechanisms (e.g., Assessors, SalariesReview, PAQ field analyses, SalaryExpert, etc.), “System and Method for Providing Occupational Information” describes collecting residual functional capacity measures (RFCs) for specific jobs (not just job families) and, at the same time, collecting skill statements. These RFCs (examples of which are shown in FIG. 3), may include job demand measures, both physical and mental (e.g., lifting, walking, crawling, reaching, stress, mental/cognitive, etc.), and can be used to define skills. Because of the way this information is collected, the techniques described in “System and Method for Providing Occupational Information” may result in a database of the average and variance measures of these RFCs for skills, which can be used, for example, in determining whether an individual should receive disability benefits in a Disability Determination Process. An example of a Disability Determination Process in one embodiment is outlined below:
1. Collect a claimant's physical location information (resident street address) and determine the claimant's “employment area” (e.g., can be based on a variable distance of commute, which is plugged in to a mileage calculator or the like).
2. Define a set of probable skills that the claimant has achieved based on information about the claimant's past industries of employment and/or information about jobs held in the past.
3. Collect information related to the claimant's education, station in life, training, age, etc.
4. Perform an initial estimate of job availability is based on industry and location (e.g. by county).
5. Perform a valuation of listed skills by industry (knowing that one may have done “lots of jobs” for an employer, rather than just one job).
6. Import any appropriate additional related work measures from a skills database (e.g., the eDOT's skills collection, which is based on RFC estimates created using skill statements completed by actual workers) as they pertain to both jobs held and skills.
7. Create a listing of alternative jobs available (e.g., via eDOT).
8. Create a listing of potential employers for those jobs in the employment area.
9. Use the facility to generate and present an indication of job board postings for occupations where claimant's skills and RFCs can meet stated requirements. This provides proof that the estimates of alternative jobs (step 7) and potential employers (step 8) are valid. An example of results from this step is illustrated in FIG. 4.

In the context of transferable skills analysis, using the facility to match skills (e.g., skills collected using the “System and Method for Providing Occupational Information”) to those found on Internet job boards, makes more sense than searching job boards by job title (note, with the facility, job title is not important, instead, the facility matches skill requirement statements).

Since the facility allows skills information to be tied to actual job availability (number of incumbents in certain jobs), it may enable keeping a record of the number of times certain skill sets are used and the trend in use of those skills. These trends may be used for educational planning nationally and internal training within large organizations, as illustrated in FIG. 5.

Like some of the tools and systems with which it is integrated (such as those described in “System and Method for Providing Occupational Information”), each operation by the facility (e.g., each search, each input at supported third party web site, each job analyzed by subject matter expert field job analysts, etc.) adds value. In other words, the more the facility and the systems with which it is integrated are used, the better the data becomes (and, the better the data, the more reason to use the facility and the systems and tools into which it is integrated).

Targeted Collection of Data for Facilitating Skill-Based Pay Assessment

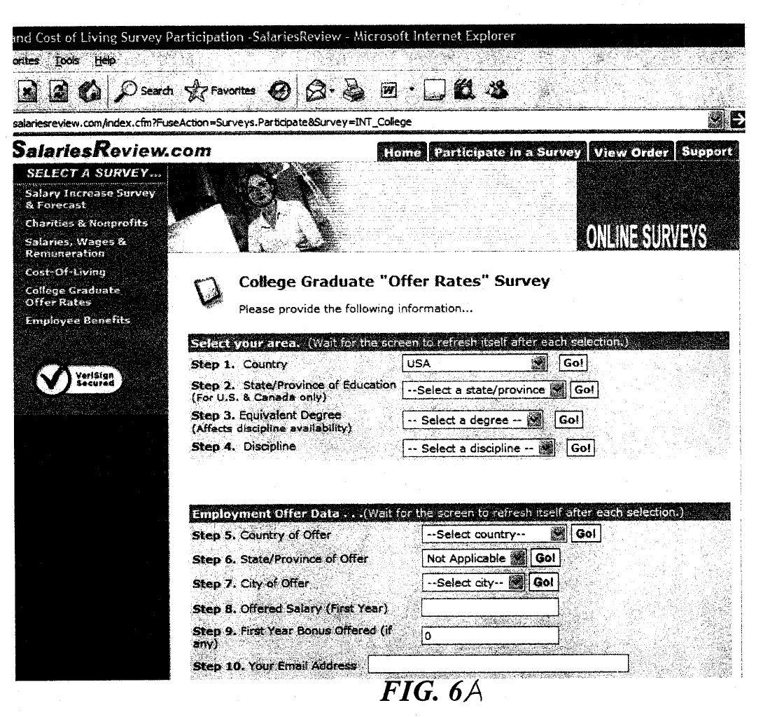

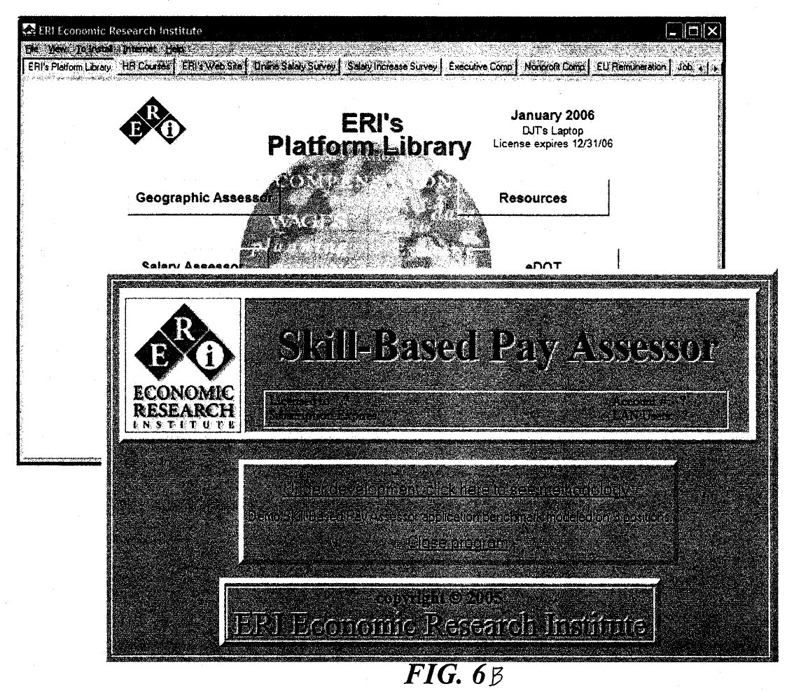

While much has been written regarding skill-based pay in the past decades, there is a lack of meaningful tools and/or data that can be used to make consistent and meaningful skill-based pay decisions. Because organizations hire for skills, organize around skills, terminate and transfer personnel for lack of skills, and pay for skills, a system that collects, stores, and analyzes skills and worker characteristics is useful in pay decision valuation. Accordingly, the facility may be configured to match given skills with skills and salary information listed on job boards, thus providing capability for creating a meaningful skill-based pay assessor (illustrated in FIG. 6). To implement the skill-based pay assessor, the facility is configured to locate actual jobs on job boards based on searching for indications of specific skills included in job board listings. In some cases, the pricing of skills has the same dynamics as the market pricing/valuation of a position (position names are oftentimes a shortcut description for the skill required). The value of a skill can vary by its application to a task, or by its application as applied to the size or industry in which it is employed. Skills become refined over time, and like positions, there are maturity curves of value that can be traced.

In the past, the study of work in America has utilized O*NET constructs, all with a construct that aggregates data, utilize complex questionnaires/models, muddles anchor scales of work measures. O*NET does, however, collect skill requirements found within job families. The facility described can parse these skills to reflect specific occupations found within these O*NET job families (java programmers, COBOL programmers, Delphi, ColdFusion, etc.) which in O*NET are simply “computer programmers.”

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. Where the context permits, words in the above Detailed Description using the singular or plural number may also include the plural or singular number, respectively.

The teachings of the invention provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the facility may vary considerably in their implementation details, while still be encompassed by the invention disclosed herein. As noted above, particular terminology used when describing certain features or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

I/we claim:

1. A system as described herein, and equivalents

2. A method as described herein, and equivalents.
